(19) United States
(12) Patent Application Publication
(10) Pub. No.: US 2026/0343170 A1
(43) Pub. Date: Oct. 29, 2026

(54) SYNCHRONIZATION OF HEAD TRACKING DATA

(71) Applicant: DOLBY LABORATORIES LICENSING CORPORATION

(72) Inventors: Xuemei Yu, Beijing (CN); Libin Luo, Beijing (CN); Zhifang Liu, Beijing (CN)

(73) Assignee: DOLBY LABORATORIES LICENSING CORPORATION, (US)

(21) Appl. No.: 19/110,881

(22) PCT Filed: Sep. 7, 2023
(86) PCT No.: PCT/US2023/073623

§ 371 Date: Mar. 12, 2025

Related U.S. Application Data
(60) Provisional application No. 63/423,265, filed on Nov. 7, 2022.
(60) Provisional application No. 63/492,724, filed on Mar. 28, 2023.

(30) Foreign Application Priority Data
Sep. 14, 2022 (WO) PCT/CN2022/118753

(51) Int. Cl. H04S 7/00; H04R 1/10; H04R 5/033

(52) U.S. Cl. CPC H04S 7/304; H04R 1/1016; H04R 5/033; H04R 2420/07; H04S 2400/11

(57) ABSTRACT

Methods, systems, and media for utilizing head tracking data are provided. In some embodiments, a method involves receiving, at each earbud of a pair of communicatively coupled earbuds, sensor data from one or more sensors. The method may involve determining, at each earbud of the pair of communicatively coupled earbuds, head orientation information. The method may involve transmitting the determined head orientation information between the pair of communicatively coupled earbuds such that a leader earbud transmits head orientation information determined by the leader earbud to a follower earbud. The method may involve synchronizing, at each earbud, the determined head orientation data based at least in part on timing information associated with a timestamp at which the head orientation information was transmitted. The method may involve utilizing the synchronized head orientation data to present audio content by each earbud of the pair of communicatively coupled earbuds.

WO

### CROSS-REFERENCE TO RELATED APPLICATIONS

This application claims the benefit of priority from PCT Application No. PCT/CN2022/118753 filed on 14 Sep. 2022, U.S. Provisional Application No. 63/423,265, filed on 7 Nov. 2022, and U.S. Provisional Application No. 63/492,724 filed on 28 Mar. 2023, each of which is incorporated by reference herein in its entirety.

### TECHNICAL FIELD

This disclosure pertains to systems, methods, and media for synchronization of head tracking related data.

### BACKGROUND

Audio content listeners may be interested in an immersive listening experience, where audio content is rendered based on head orientation. However, it can be difficult to accurately monitor head orientation and render audio content based on head orientation.

### NOTATION AND NOMENCLATURE

Throughout this disclosure, including in the claims, the terms “speaker,” “loudspeaker” and “audio reproduction transducer” are used synonymously to denote any sound-emitting transducer (or set of transducers). A typical set of headphones includes two speakers. A speaker may be implemented to include multiple transducers (e.g., a woofer and a tweeter), which may be driven by a single, common speaker feed or multiple speaker feeds. In some examples, the speaker feed(s) may undergo different processing in different circuitry branches coupled to the different transducers.

Throughout this disclosure, including in the claims, the expression performing an operation “on” a signal or data (e.g., filtering, scaling, transforming, or applying gain to, the signal or data) is used in a broad sense to denote performing the operation directly on the signal or data, or on a processed version of the signal or data (e.g., on a version of the signal that has undergone preliminary filtering or pre-processing prior to performance of the operation thereon).

Throughout this disclosure including in the claims, the expression “system” is used in a broad sense to denote a device, system, or subsystem. For example, a subsystem that implements a decoder may be referred to as a decoder system, and a system including such a subsystem (e.g., a system that generates X output signals in response to multiple inputs, in which the subsystem generates M of the inputs and the other X-M inputs are received from an external source) may also be referred to as a decoder system.

Throughout this disclosure including in the claims, the term “processor” is used in a broad sense to denote a system or device programmable or otherwise configurable (e.g., with software or firmware) to perform operations on data (e.g., audio, or video or other image data). Examples of processors include a field-programmable gate array (or other configurable integrated circuit or chip set), a digital signal processor programmed and/or otherwise configured to perform pipelined processing on audio or other sound data, a programmable general purpose processor or computer, and a programmable microprocessor chip or chip set.

### SUMMARY

Methods, systems, and media for utilizing head tracking data are provided. In some embodiments, a method involves receiving, at each earbud of a pair of communicatively coupled earbuds, sensor data from one or more sensors. The method may involve determining, at each earbud of the pair of communicatively coupled earbuds, head orientation information. The method may involve transmitting the determined head orientation information between the pair of communicatively coupled earbuds such that a leader earbud of the pair of communicatively coupled earbuds transmits head orientation information determined by the leader earbud to a follower earbud of the pair of communicatively coupled earbuds. The method may involve synchronizing, at each earbud of the pair of communicatively coupled earbuds, the determined head orientation data based at least in part on timing information associated with a timestamp at which the head orientation information was transmitted. The method may involve utilizing the synchronized head orientation data to present audio content by each earbud of the pair of communicatively coupled earbuds.

In some examples, determining the head orientation information at each earbud comprises fusing data from two or more sensors disposed in or on the earbud.

In some examples, determining the head orientation information comprises determining predicted head orientation data. In some examples, the follower earbud is configured to utilize the predicted head orientation data to compensate for latency in receiving the head orientation information from the leader earbud.

In some examples, the method further involves smoothing the synchronized head orientation data, wherein the synchronized head orientation data utilized to present audio content comprises the smoothed synchronized head orientation data.

In some examples, transmitting the determined head orientation information between the pair of communicatively coupled earbuds comprises including the timing information in a data stream transmitted from the leader earbud to the follower earbud. In some examples, the method further involves determining, at the follower earbud, whether data is missing in the head orientation information received from the leader earbud based at least in part on the timing information received from the leader earbud. In some examples, synchronizing the determined head orientation data at the follower earbud comprises synchronizing the determined head orientation data determined at the follower earbud based on the one or more sensors of the follower earbud with the head orientation data received from the leader earbud using the timing information.

In some examples, determining, at each earbud, the head orientation information comprises recentering head orientation data generated based on the sensor data to compensate for drift in the sensor data.

In some examples, each earbud comprises a cache buffer to store at least the head orientation data. In some examples, head orientation data is transmitted from a cache buffer of the leader earbud to the follower earbud at a timing interval dependent on at least a data transmission rate and a latency associated with transmitting the determined head orientation information between the pair of communicatively coupled earbuds.

In some examples, the method further involves resampling the sensor data prior to determining the head orientation information to compensate for a difference between a sampling rate used to acquire the sensor data and a sampling rate used to determine the head orientation information.

In some examples, the method further involves resampling the determined head orientation information prior to transmitting the determined head orientation information to compensate for a difference between a sampling rate used to determine the head orientation information and a sampling rate used to transmit the determined head orientation information.

In some examples, the method further involves resampling the synchronized head orientation data prior to utilizing the synchronized head orientation data to present the audio content to compensate for a difference between a sampling rate used to synchronize the determined head orientation data and a sampling rate used to process the audio content.

In some examples, transmitting the determined head orientation information comprises utilizing a BLUETOOTH communication protocol.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented via one or more non-transitory media having software stored thereon.

At least some aspects of the present disclosure may be implemented via an apparatus. For example, one or more devices may be capable of performing, at least in part, the methods disclosed herein. In some implementations, an apparatus is, or includes, an audio processing system having an interface system and a control system. The control system may include one or more general purpose single-or multi-chip processors, digital signal processors (DSPs), application specific integrated circuits (ASICs), field programmable gate arrays (FPGAs) or other programmable logic devices, discrete gates or transistor logic, discrete hardware components, or combinations thereof.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating a pair of earbuds in accordance with some embodiments.

FIG. 2 is a schematic block diagram of a system for synchronizing head tracking data in accordance with some embodiments.

FIG. 3 is a schematic block diagram of components of an earbud in accordance with some embodiments.

FIG. 4 is a schematic block diagram of an example system for determining head tracking information in accordance with some embodiments.

FIGS. 5A and 5B are schematic block diagrams of example data synchronization systems for a leader earbud and a follower earbud, respectively, in accordance with some implementations.

FIGS. 6A and 6B are schematic block diagrams of example data transferring systems for a leader earbud and a follower earbud, respectively, in accordance with some implementations.

FIG. 7 is a flowchart of an example process for synchronizing and utilizing head orientation information by a pair of earbuds in accordance with some implementations.

FIG. 8 shows a block diagram that illustrates examples of components of an apparatus capable of implementing various aspects of this disclosure.

Like reference numbers and designations in the various drawings indicate like elements.

### DETAILED DESCRIPTION OF EMBODIMENTS

Audio content consumers are increasingly interested in immersive audio content. Immersive audio content may be audio content that includes spatial positioning information (e.g., audio objects that are to be perceived as being located in particular spatial locations). When rendered by headphones, such immersive content may be rendered based on a head orientation of the listener wearing the headphones. As used herein, “immersive content” refers to audio data that is rendered with reference to an external reference frame, such as a reference frame defined by a display screen that is presenting a movie, a television show, etc. Conventionally, over the head headphones may include one or more processors and one or more sensors that are used to generate head orientation data from which the audio content is rendered. However, for earbuds, in which each earbud of a pair of earbuds is physically separate, rendering based on head orientation may be more difficult. For example, each earbud may have its own set of sensors that generate sensor data from which head orientation is determined. However, due to having two physically separate earbuds, the head orientation determined by each earbud may be different, perhaps even substantially different, thereby causing errors or inaccuracies in the rendered audio content.

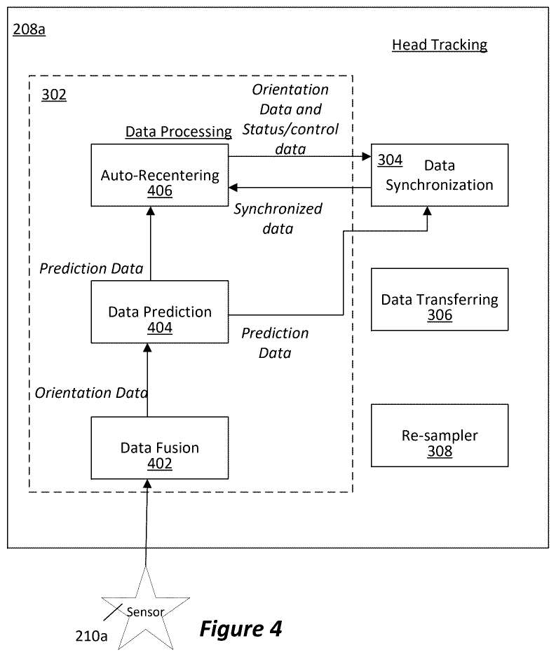

Disclosed herein are systems, methods, and techniques for synchronizing head orientation data and status and control information across a pair of earbuds. Each earbud may have its own set of sensors, which may include one or more accelerometers, one or more gyroscopes, one or more magnetometers, or the like. Each earbud may then generate head orientation data based on the sensor data. The head orientation data may be shared between the pair of earbuds using a wireless communication channel. For example, the wireless communication channel may utilize the BLUETOOTH communication protocol, or any other suitable wireless communication protocol. Each earbud may then synchronize the head orientation data generated by itself with the head orientation data received by the paired earbud. This may allow for a more robust determination of head orientation, which may in turn allow for more robust rendering of the audio content. Note that, as used herein, status/control information may include timing information (e.g., timestamp information, counting information, and any other timing related information) that may be used for latency compensation (e.g., to compensate for the transfer latency of transferring data between two paired earbuds). Additionally or alternatively, status/control information may include data generated at a first earbud and transmitted to a paired earbud configured to be used in re-centering head orientation data (e.g., to account for and/or compensate for system drift associated with sensors). The data may be used by, e.g., a re-centering block, as shown in and described below in connection with FIG. 4.

In some implementations, a first earbud of the pair may be designated a leader earbud, and the second earbud of the pair may be designated a follower earbud. The leader earbud may generate timestamp or counting data that may be included in a data stream that is transmitted to the follower earbud. In some embodiments, the follower earbud may utilize the timestamp or counting data to detect missing or delayed data (e.g., due to a weak signal strength of the wireless communication channel, interference from a nearby device, etc.) and may then compensate for the missing or delayed data. In some embodiments, each earbud may be configured to generate predicted head orientation data, e.g., a prediction of a future head orientation of the listener. The predicted head orientation data may be used to compensate for missing or delayed head orientation data from the paired earbud.

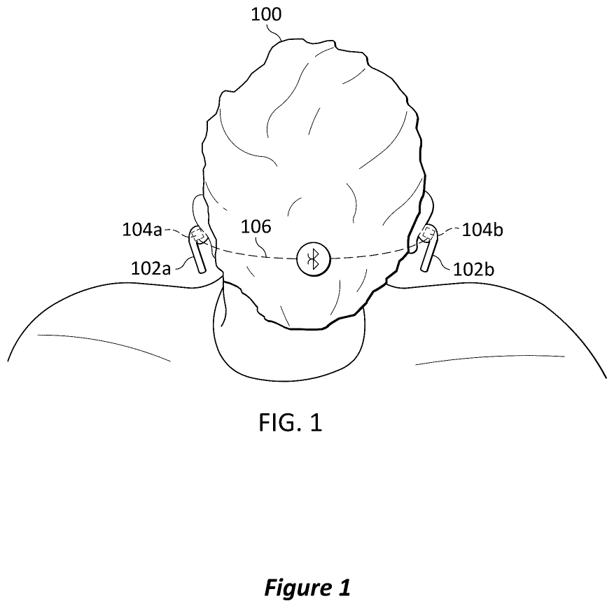

FIG. 1 illustrates an example listening scenario in accordance with some embodiments. As illustrated, a listener 100 may be listening to audio content using a pair of earbuds, which may include a left earbud 102a and a right earbud 102b. The two earbuds may be communicatively coupled via a wireless communication channel 106. In one example, the wireless communication channel may be a BLUETOOTH communication channel, as shown in FIG. 1. Each earbud may include hardware circuitry, which may include one or more sensors configured to provide sensor data indicative of a user head orientation. For example, the one or more sensors may include one or more accelerometers, one or more gyroscopes, one or more magnetometers, or the like. The circuitry of each earbud may additionally include one or more processors configured to process the sensor data, determine a head orientation based on the sensor data, predict a future head orientation based on the sensor data, transmit and/or receive communications from a paired mobile device and/or the other earbud, or the like. In the example of FIG. 1, left earbud 102a includes circuitry 104a, and right earbud 102b includes circuitry 104b.

In some implementations, each earbud of a pair of earbuds may include one or more sensors configured to provide sensor data which may be used to determine head orientation. The two earbuds may be communicatively coupled (e.g., via a wireless communication channel) such that the two earbuds may share information associated with head orientation, timing information, status and control information, etc. Each earbud may also be communicatively coupled (e.g., via a wireless communication channel) to a user device that provides audio content. Each earbud may be configured to render audio content received from the paired user device using the head orientation information, and to then play the rendered audio content by outputting the rendered audio signal. Note that, in some implementations, one of the earbuds of the pair of earbuds may be considered a leader, and the other earbud may be considered a follower. The leader earbud may provide instructions, timing information, or the like to the follower earbud. The follower earbud may synchronize the head orientation information obtained using its own sensors with head orientation information obtained from the leader earbud. This synchronization may be used to overcome differences between the sensors of each of the two earbuds, jitter or communication latency between the two earbuds and/or the mobile device, or the like.

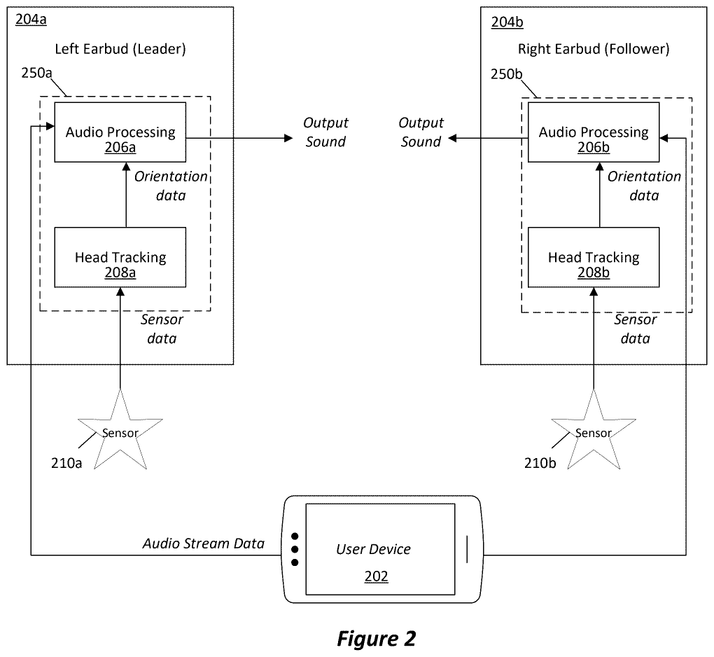

FIG. 2 is a diagram of an example system for synchronizing head orientation and utilizing the synchronized head orientation information in accordance with some embodiments. As illustrated, a user device 202 provides audio stream data to a leader earbud 204a and a follower earbud 204b. Note that although FIG. 2 indicates that the leader earbud 204a is the left earbud, and the follower earbud 204b is the right earbud, in other embodiments, the leader earbud may be the right earbud and the follower earbud may be the left earbud. The audio stream data may be audio content of a movie or television show, audio content associated with music, audio content associated with a podcast, or the like. The audio stream data may include one or more audio objects that are to be rendered at particular spatial positions with respect to the user's head based on a user's head orientation data.

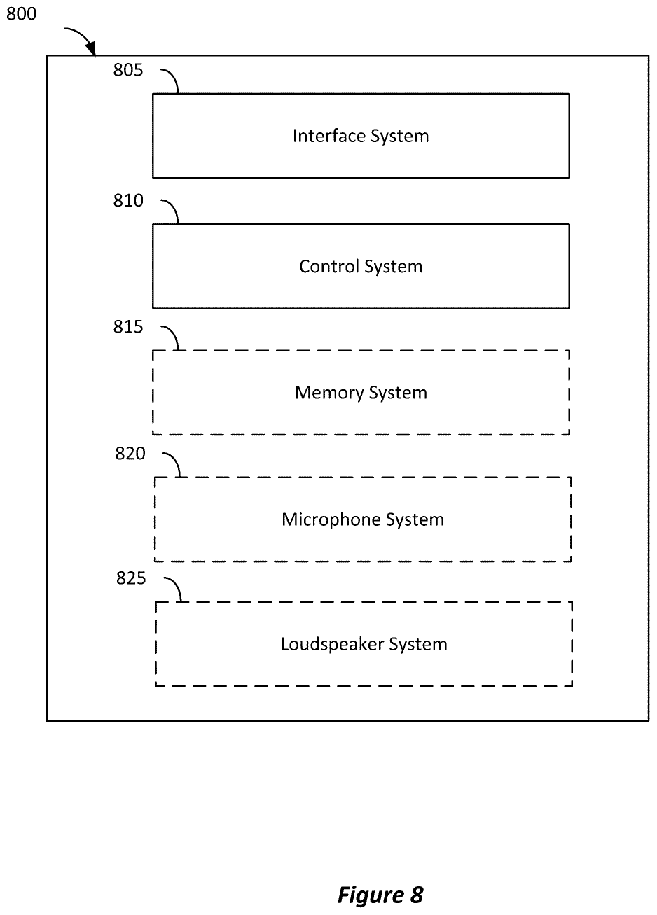

Each earbud may include an audio processing block configured to receive the audio stream data from user device 202 and render the audio stream data based on head orientation data. The audio processing block may then be configured to play the rendered audio data. As illustrated, leader earbud 204a includes audio processing block 206a, and follower earbud 204b includes audio processing block 206b. It should be understood that as used herein, a “block” may be implemented in software, e.g., as one or more functions. The software may be executed by one or more processors or one or more control systems each disposed in or on a given earbud, in or on a user device paired with the earbuds, or the like. An example of a processor or a control system that may be used to implement a “block” is shown in and described below in connection with FIG. 8. In the example shown in FIG. 2, control system 250a is configured to implement audio processing block 206a and control system 250b is configured to implement audio processing block 206b. Control systems 250a and 250a are instances of the control system 810 that is described herein with reference to FIG. 8.

Each audio processing block is configured to receive head orientation data from a corresponding head tracking block. For example, audio processing block 206a receives head orientation data from head tracking block 208a, and audio processing block 206b receives head orientation data from head tracking block 208b. Each head tracking block is configured to generate the head orientation data based on sensor data received from one or more sensors. In the example shown in FIG. 2, control system 250a is configured to implement head tracking block 206a and control system 250b is configured to implement head tracking block 206b. Note that each earbud has its own set of one or more sensors disposed in or on the earbud. For example, leader earbud 204a may utilize set of sensors 210a, and follower earbud 204b may utilize set of sensors 210b. The set of sensors may include one or more accelerometers, one or more magnetometers, one or more gyroscopes, or the like.

In some implementations, each earbud may obtain sensor data from one or more sensors disposed in or on the earbud and may use the sensor data to determine a head orientation of the wearer of the earbuds. The head orientation data may be determined by one or more processors of the earbud. The head orientation data may be shared with a paired earbud. For example, a left earbud may share head orientation data with a paired right earbud and vice versa. The head orientation data may be shared via a wireless communication channel between the two paired earbuds. Shared head orientation data may be used to determine a more robust head orientation (e.g., due to use of multiple sensors on two different earbuds) thereby allowing for more robust rendering of the audio data. Note that, in some implementations, each earbud may determine predicted head orientation data which may be used to compensate for dropped data packets and/or latency in receiving the shared head orientation data from the paired earbud. For example, predicted head orientation data determined at a first earbud may be used in instances in which head orientation data from a paired second earbud is delayed or dropped. Data between the two paired earbuds may be synchronized. The data may be synchronized using timing information shared between the two paired earbuds. For exampling, the timing information may be shared by adding timestamp data to a data stream that includes head orientation data. In some embodiments, synchronized head orientation data may be used to re-center control data used to render the audio content. This may compensate for drift in sensor data which causes a drift in head orientation data.

Note that, in some embodiments, different aspects of a head orientation data synchronization and utilization system may operate at different sampling frequencies. For example, sensor data may be collected by sensors having a sensor driver that operates at a particular sensor sampling frequency (e.g., 100 Hz, 104 Hz, 110 Hz, or the like), whereas head-tracking orientation determination may occur with a processor that operates at a different rate (e.g., 40 Hz, 50 Hz, 60 Hz, etc.). As another example, audio processing may occur within a range of about 90 Hz-120 Hz. In one example, audio processing may occur at 93.75 Hz (e.g., by processing 512 samples at a 48 KHz sampling rate). As yet another example, data may be transferred between the two earbuds at a data communication rate of 20 Hz. To account for the different sampling rates between different sub-systems, each earbud may include a resampling block configured to resample data from a first sampling rate to a second sampling rate. The resampling block may be executed by one or more processors of the earbud.

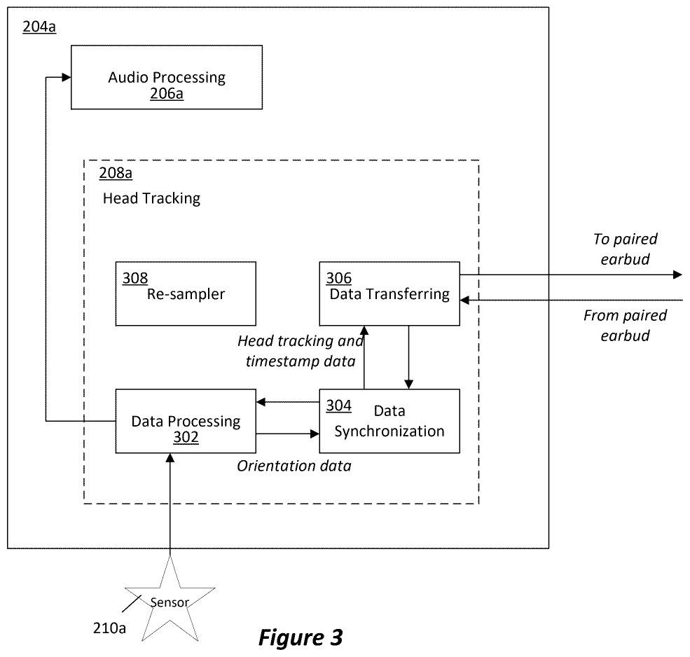

FIG. 3 is a schematic block diagram of components of an example earbud. Note that although FIG. 3 indicates that the earbud is earbud 204a, corresponding to the leader earbud shown in and described above in connection with FIG. 2, the same or similar components may be included in a follower earbud, such as follower earbud 204b of FIG. 2. In some implementations, various components may be implemented in software and may be executed by one or more processors or one or more control systems disposed in or on the earbud. An example of such a processor or control system is shown in and described below in connection with FIG. 8. As illustrated in FIG. 3, earbud 204a includes a head tracking block 208a configured to determine head orientation data based on data from sensor 210a. Head tracking block 208a provides head orientation data to audio processing block 206a, and transmits an indication of the head orientation data to a paired earbud (which may be follower earbud 204b of FIG. 2).

As illustrated in FIG. 3, head orientation data may be determined by a data processing block 302, which receives the sensor data and determines the head orientation data. More detailed techniques that may be utilized by data processing block 302 are shown in and described below in connection with FIG. 4.

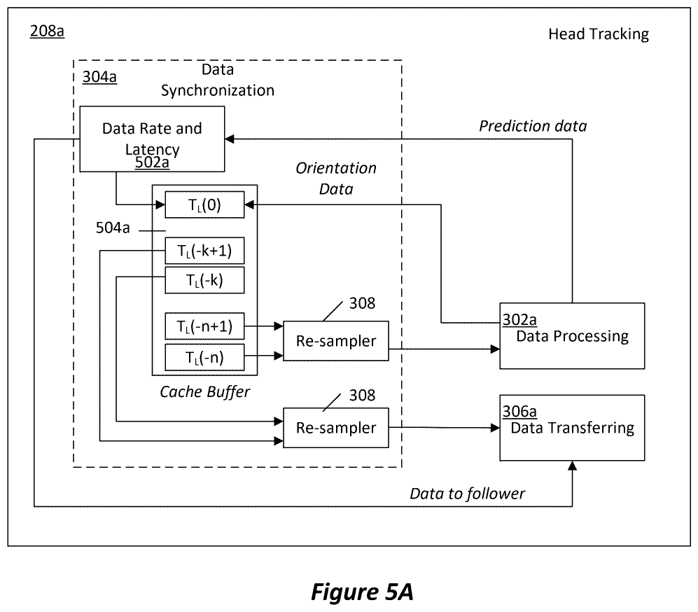

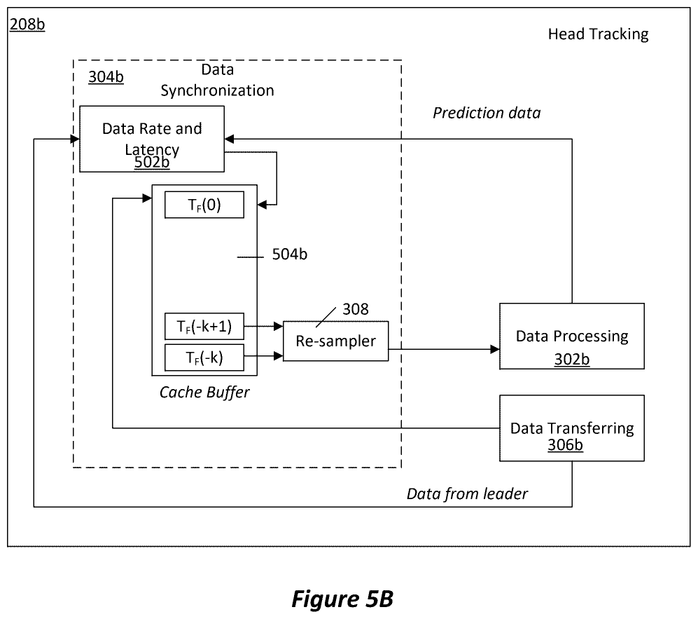

Data processing block 302 is in communication with data synchronization block 304. As illustrated, data synchronization block 304 is also in communication with data transferring block 306. Regarding outbound data, data synchronization block 304 may generate and apply timestamp data to a data stream that includes the head orientation data (and predicted head orientation data, and/or status and control information) generated by data processing block 302. The head orientation data, predicted head orientation data, status and control information, and timestamp data may be provided to data transferring block 306. Regarding inbound data, data synchronization block 304 may receive head orientation data and predicted head orientation data from data transferring block 306 (which in turn received the data from the paired earbud) and may synchronize the data from the paired earbud with head orientation data obtained using the sensors of the given earbud. The synchronized data and status/control information may be provided to data processing block 302 for use by audio processing block 206a. More detailed techniques that may be implemented by data synchronization block 304 are shown in and described below in connection with FIG. 5A (for a leader earbud) and FIG. 5B (for a follower earbud).

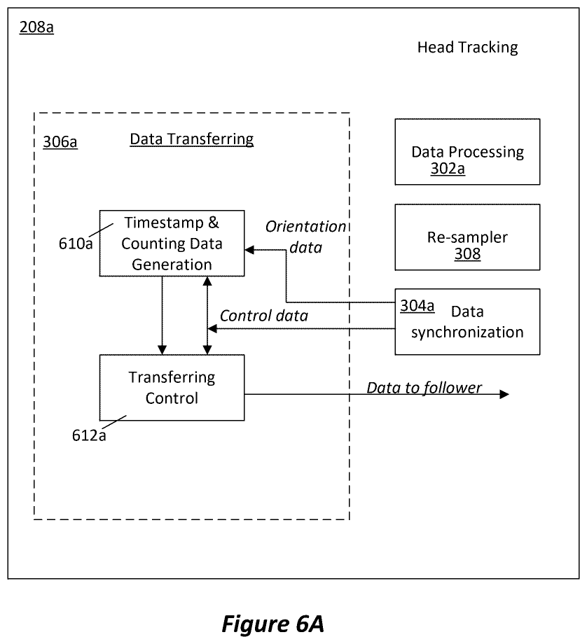

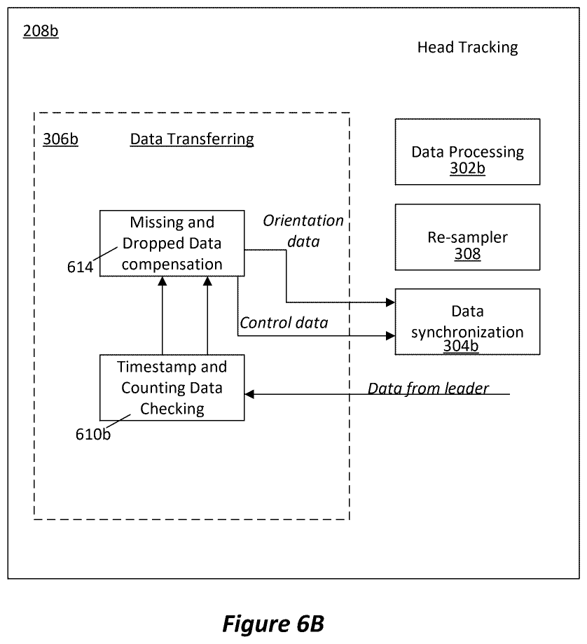

Data transferring block 306 may transmit head orientation data, predicted head orientation data, status/control information and timestamp information to the paired earbud. Data transferring block 306 may also receive head orientation data, predicted head orientation data, and timestamp information from the paired earbud. More detailed techniques that may be implemented by data transferring block 306 are shown in and described below in connection with FIG. 6A (for a leader earbud) and FIG. 6B (for a follower earbud).

As illustrated, the system includes a re-sampler block 308, which is configured to transform data from a first sampling rate to a second sampling rate. Re-sampler block 308 may be used by any of data processing block 302, data synchronization block 304, data transferring block 306, or audio processing block 206a to convert from one sampling rate to another sampling rate.

In some implementations, one or more processors of an earbud may receive sensor data from one or more sensors. The sensor data may include motion data from e.g., one or more accelerometers and/or one or more gyroscopes. The one or more processors may utilize data fusion to transform the motion data to head orientation data. The one or more sensors may additionally predict future head orientation data. The predicted head orientation data may be used to compensate for, e.g., latency in receiving head orientation data from the paired earbud. The one or more processors may perform auto-recentering to correct for drift in the prevision of the motion data provided by the one or more sensors. In some implementations, auto-recentering may be performed by generating status-control information. In some embodiments, a leader earbud may transmit the status-control information to the follower earbud such that the leader earbud generates recentering data that is utilized by both the leader earbud and the follower earbud.

FIG. 4 is a schematic block diagram that illustrates components of an example data processing block in accordance with some implementations. In some implementations, data processing block and/or components of the data processing block may be implemented as software that may be executed by one or more processors and/or one or more control systems of a given earbud. An example of such a processor or control system is shown in and described below in connection with FIG. 8. Note that although FIG. 4 is depicted as including a head tracking block 208a of a leader earbud (e.g., leader earbud 204a of FIG. 2), the same or similar components may be included in a head tracking block of a follower earbud (e.g., follower earbud 204b of FIG. 2). As illustrated, a data processing block 302 may include a data fusion block 402, a data prediction block 404, and an auto-recentering block 406. Data fusion block 202 may be configured to receive sensor data from sensors 210a, which may be motion data (e.g., from one or more accelerometers and/or one or more gyroscopes) and transform the sensor data to head orientation data. In some implementations, the head orientation data may be provided to data prediction block 404. Data prediction block 404 may generate predicted head orientation data, e.g., at one or more future times. The predicted head orientation data may be provided to auto-recentering block 406 and/or data synchronization block 304. Auto-recentering block 406 may be configured to generate status/control information that is usable to adjust head orientation data to compensate for drift in the sensors 210a. The recentered head orientation data may be provided to data synchronization block 304, which may synchronize the recentered head orientation data with head orientation data received from the paired earbud. Note that auto-recentering block 406 may additionally receive data from data synchronization block 304, e.g., head orientation data received from the paired earbud.

In some implementations, data synchronization may use a cache buffer configured to store orientation data. Data may be placed in the cache buffer and/or retrieved from the cache buffer at various timestamps. The timestamps may be dependent on a data transmission rate (e.g., a data transmission rate associated with data transmission between two paired earbuds), a data transmission latency (e.g., a latency associated with data transmission between two paired earbuds, data transmission jitter, and/or data buffer delay. In some embodiments, data may be stored in and/or retrieved from the cache buffer in a different manner for a leader earbud relative to a follower earbud. For example, for a leader earbud, data may be placed in the cache buffer at time T_{L}(0). Continuing with this example, synchronized data may be set to an audio processing block at time T_{L}(−n), where −n refers to n samples prior to time 0, at which new data was placed in the cache buffer. In other words, data older than the current time may be transmitted to the audio processing block. The index n may be based on the data transmission rate, the data transmission latency and/or the data buffer delay. Data to be synchronized at the paired earbud may be sent to a transfer block at a time of T_{L}(−k), where −k refers to k samples prior to time 0, at which the new data was placed in the cache buffer. The index k may be based on the time difference between data processing and data transmission, and/or a head-room for data transmission jittering. Note that index k corresponds to data for the paired earbud, and a time difference between index n and index k corresponds to a compensation for a data transferring latency between the paired earbuds. In some embodiments, both the leader and follow earbuds may process data for T(−k) at substantially the same time. In some embodiments, index n is greater than index k, because the nth data may be sent to the processing block at the present time, and the kth data may be sent to the paired earbud and processed later Referring to the follower earbud, the cache buffer may receive data at a time of T_{F}(0). Synchronized data (e.g., synchronized with data from the leader earbud) may be sent to the audio processing block at time T_{F}(−m), where index m may be based on the data transmission rate, the data transmission latency, the data transmission jitter, and/or the data buffer delay. Note that, the data at index m may correspond to data generated m samples before the current time and that is predicted for a time corresponding to the current time.

FIG. 5A depicts example components of a data synchronization block of a leader earbud, and FIG. 5B depicts example components of a data synchronization block of a follower earbud. In some embodiments, a data synchronization block and/or components of a data synchronization block may be implemented as software that may be executed by one or more processors or one or more control systems of a given earbud. An example of such a processor or control system is shown in and described below in connection with FIG. 8. Referring to FIG. 5A, a data synchronization block 304a may include a data rate and latency block 502a and a cache buffer 504a. Predicted head orientation data may be transmitted from a data processing block 302a of the leader earbud to data rate and latency block 502a. Data processing block 302a may transmit orientation data to cache buffer 504a. The predicted head orientation data at T_{L}(0). Data rate and latency block 502a may generate control information that is used for synchronizing data. The cache buffer may include data stored in the cache buffer at previous (e.g., older) times. For example, data stored at T_{L}(−k+1) and/or T_{L}(−k) may be provided to data transferring block 306a for transmittal to the paired follower earbud. Note that prior to transfer, the data may be re-sampled by re-sampler block 308. As another example, data stored at T_{L}(−n+1) and/or T_{L}(−n) may be provided to data processing block 302a for provision to data processing block 302a.

Referring to FIG. 5B, example components of a data synchronization block of a follower earbud are depicted in accordance with some implementations. Data synchronization block 304b may include a data rate and latency block 502b and a cache buffer 504b. Data rate and latency block 502b may receive data from a data transferring block 306b that includes head orientation data and/or predicted head orientation data from a leader earbud. Data rate and latency block 502b may additionally receive predicted head orientation data from a data processing block 302b. New data may be stored in cache buffer 504b at a time T_{F}(0). Data may be retrieved from cache buffer 504b and transmitted to data processing block 302b at earlier time stamps, e.g., T_{F}(−k+1) and/or T_{F}(−k).

As described above, a pair of earbuds may be communicatively coupled, e.g., using a wireless communication channel such as a communication channel that abides by a BLUETOOTH protocol. Due to a limited bandwidth, a weak signal, and/or interference from a nearby device, there may be dropped data packets and/or a latency in delivered data packets. To compensate for dropped or delayed data, a leader earbud may transmit timing information that may be used by a follower earbud to detect dropped packets. For example, the timing information may include packet counts or other counting information that may be used by the follower earbud to detect missing packets or delayed packets. Note that, in some embodiments, counting information may be used to check for dropped data packets, and timestamp information may provide more accurate information for monitoring and/or generating time-based calculations of latency and/or sampling. The timing information may additionally or alternatively include timestamps, e.g., a timestamp at which head orientation information was transmitted. Note that this timing information may be used by the follower earbud to synchronize head orientation data. In some implementations, responsive to detecting dropped or delayed data, a follower earbud may compensate for the missing or delayed data. For example, the follower earbud may utilize the last received head orientation data, smooth recent head orientation data (e.g., the latest N samples), re-sample previously received head orientation data, or any combination thereof. This compensated orientation data may then be used for synchronization and/or processing.

FIG. 6A illustrates example components that may be used by a data transferring block of a leader earbud for generating and utilizing timing information in accordance with some embodiments. In some implementations, a data transferring block, or components of a data transferring block, may be implemented as software which may be executed by one or more processors and/or one or more control systems of a given earbud. An example of such a processor or control system is shown in and described below in connection with FIG. 8. As illustrated, data transferring block 306a may include a timestamp and counting data generation block 610a and a transferring control block 612a. Timestamp and counting data generation block 610a may receive orientation data and/or control data generated by data synchronization block 304a, and may provide timing information and/or counting information to transferring control block 612a. Transferring control block 612a may then generate a data stream that includes both the head orientation data generated by the leader earbud and the timing information and/or counting information and cause the generated data stream to be transmitted to the follower earbud (e.g., via a BLUETOOTH communication channel, or any other suitable wireless communication channel). Transferring control block 612a may trigger the transmission of the data stream at a pre-defined interval and/or within predetermined timing.

FIG. 6B illustrates example components that may be used by a data transferring block of a follower earbud for receiving and utilizing timing information in accordance with some embodiments. In some implementations, a data transferring block, or components of a data transferring block, may be implemented as software which may be executed by one or more processors and/or one or more control systems of a given earbud. An example of such a processor or control system is shown in and described below in connection with FIG. 8. As illustrated, a data transferring block 306b may include a timestamp and counting data checking block 610b and a missing and dropped data compensation block 614. Timestamp and counting data checking block 610b may receive a data stream from a leader earbud, which may include head orientation data and timestamp and/or counting data. Based on the timestamp and/or counting data, timestamp and counting data checking block 610b may detect dropped and/or delayed data packets of the head orientation data. Timestamp and counting data checking block 610b may transmit information indicative of the dropped and/or delayed data packets to missing and dropped data compensation block 614. Missing and dropped data compensation block 614 may then generate replacement data (e.g., by utilizing previously received data, re-sampling previously received data, smoothing previously received data, or any combination thereof). The received and/or replacement data may be provided to data synchronization block 304b in order to synchronize the head orientation data from the leader earbud with the head orientation data generated by the follower earbud.

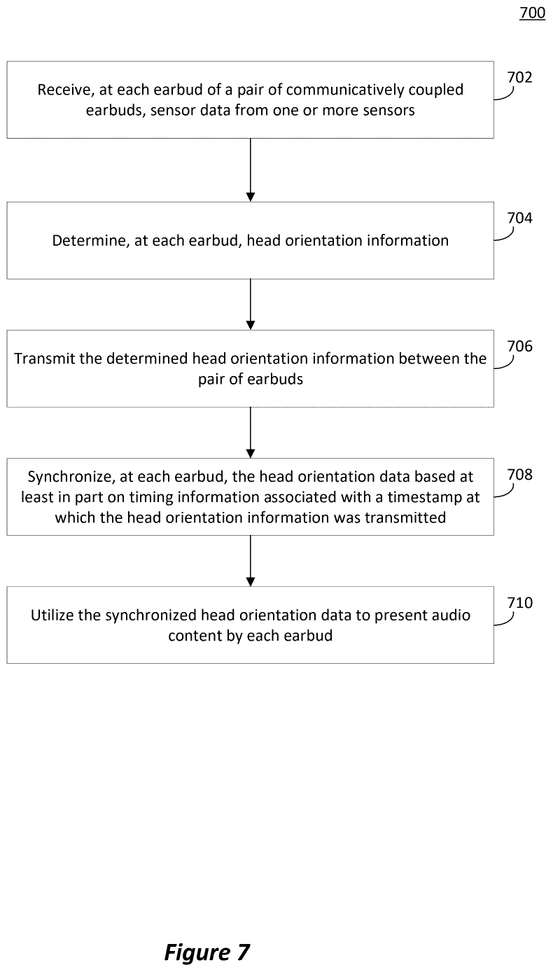

FIG. 7 is a flowchart of an example process 700 for generating and utilizing head orientation data by a pair of earbuds. Note that blocks of process 700 may be executed by processors or control system on each earbud of the pair of earbuds. An example of such a processor or control system is shown in and described below in connection with FIG. 8. As described above, the pair of earbuds may include a leader earbud and a follower earbud. In some embodiments, blocks of process 700 may be executed in an order other than what is shown in FIG. 7. In some implementations, two or more blocks of process 700 may be executed substantially in parallel. In some implementations, one or more blocks of process 700 may be omitted.

At 702, process 700 may begin by receiving, at each earbud of a pair of communicatively coupled earbuds, sensor data from one or more sensors. The one or more sensors may be disposed in or on each earbud. The one or more sensors may include one or more accelerometers, one or more gyroscopes, one or more magnetometers, etc.

At 704, process 700 may determine, at each earbud, head orientation information. For example, process 700 may transform raw sensor data indicating motion to head orientation information using data fusion. Note that, in some embodiments, the head orientation information may include head orientation prediction data that indicates predicted head orientation at one or more future timepoints. The predicted head orientation data may be used to compensate for missing or dropped data packets from the paired earbud. In some embodiments, head orientation information may be determined by a data processing block of each earbud. Example components of a data processing block are shown in and described above in connection with FIG. 4.

At 706, process 700 may transmit the determined head orientation information between the pair of earbuds. For example, a leader earbud may generate a data stream that includes the head orientation information and timing information that may be used by the follower earbud to detect missing or delayed data. As another example, the follower earbud may transmit head orientation data to the leader earbud. By sharing the head orientation information between the pair of earbuds, more robust head orientation information may be determined, which may in turn allow for more robust rendering of audio content. The head orientation information may be transmitted from a given earbud using a data transferring block. Example components of a data transferring block are shown in and described above in connection with FIG. 6A (for a leader earbud) and FIG. 6B (for a follower earbud).

At 708, process 700 may synchronize, at each earbud, the head orientation data based at least in part on timing information associated with a timestamp at which the head orientation information was transmitted. For example, each earbud may synchronize the head orientation information it generated based on the sensors disposed in or on the earbud itself with the head orientation information received from the paired earbud. Synchronization may be performed by a data synchronization block. Example components of a data synchronization block are shown in and described above in connection with FIG. 5A (for a leader earbud) and FIG. 5B (for a follower earbud).

At 710, process 700 may utilize the synchronized head orientation data to present audio content by each earbud. For example, process 700 may render audio stream data provided by a paired user device (e.g., a mobile phone, a tablet computer, a smart television, a gaming console, a desktop computer, a laptop computer, etc.) based on the synchronized head orientation data. The audio stream may be rendered using spatial metadata associated with the audio stream data that indicates how the head orientation data is to be used to render the audio stream. The rendered audio stream may then be played back using each of the earbuds.

FIG. 8 is a block diagram that shows examples of components of an apparatus capable of implementing various aspects of this disclosure. As with other figures provided herein, the types and numbers of elements shown in FIG. 8 are merely provided by way of example. Other implementations may include more, fewer and/or different types and numbers of elements. According to some examples, the apparatus 800 may be configured for performing at least some of the methods disclosed herein. In some implementations, the apparatus 800 may be, or may include, a television, one or more components of an audio system, a mobile device (such as a cellular telephone), a laptop computer, a tablet device, a smart speaker, or another type of device.

According to some alternative implementations the apparatus 800 may be, or may include, a server. In some such examples, the apparatus 800 may be, or may include, an encoder. Accordingly, in some instances the apparatus 800 may be a device that is configured for use within an audio environment, such as a home audio environment, whereas in other instances the apparatus 700 may be a device that is configured for use in “the cloud,” e.g., a server.

In this example, the apparatus 800 includes an interface system 805 and a control system 810. The interface system 805 may, in some implementations, be configured for communication with one or more other devices of an audio environment. The audio environment may, in some examples, be a home audio environment. In other examples, the audio environment may be another type of environment, such as an office environment, an automobile environment, a train environment, a street or sidewalk environment, a park environment, etc. The interface system 805 may, in some implementations, be configured for exchanging control information and associated data with audio devices of the audio environment. The control information and associated data may, in some examples, pertain to one or more software applications that the apparatus 800 is executing.

The interface system 805 may, in some implementations, be configured for receiving, or for providing, a content stream. The content stream may include audio data. The audio data may include, but may not be limited to, audio signals. In some instances, the audio data may include spatial data, such as channel data and/or spatial metadata. In some examples, the content stream may include video data and audio data corresponding to the video data.

The interface system 805 may include one or more network interfaces and/or one or more external device interfaces (such as one or more universal serial bus (USB) interfaces). According to some implementations, the interface system 805 may include one or more wireless interfaces. The interface system 805 may include one or more devices for implementing a user interface, such as one or more microphones, one or more speakers, a display system, a touch sensor system and/or a gesture sensor system. In some examples, the interface system 805 may include one or more interfaces between the control system 810 and a memory system, such as the optional memory system 815 shown in FIG. 8. However, the control system 810 may include a memory system in some instances. The interface system 805 may, in some implementations, be configured for receiving input from one or more microphones in an environment.

The control system 810 may, for example, include a general purpose single-or multi-chip processor, a digital signal processor (DSP), an application specific integrated circuit (ASIC), a field programmable gate array (FPGA) or other programmable logic device, discrete gate or transistor logic, and/or discrete hardware components.

In some implementations, the control system 810 may reside in more than one device. For example, in some implementations a portion of the control system 810 may reside in a device within one of the environments depicted herein and another portion of the control system 810 may reside in a device that is outside the environment, such as a server, a mobile device (e.g., a smartphone or a tablet computer), etc. In other examples, a portion of the control system 810 may reside in a device within one environment and another portion of the control system 810 may reside in one or more other devices of the environment. For example, a portion of the control system 810 may reside in a device that is implementing a cloud-based service, such as a server, and another portion of the control system 810 may reside in another device that is implementing the cloud-based service, such as another server, a memory device, etc. The interface system 805 also may, in some examples, reside in more than one device. In some implementations, a portion of a control system may reside in or on an earbud.

In some implementations, the control system 810 may be configured for performing, at least in part, the methods disclosed herein. According to some examples, the control system 810 may be configured for implementing methods of synchronizing head tracking information, re-sampling data, predicting head tracking information, rendering audio data, or the like.

Some or all of the methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. The one or more non-transitory media may, for example, reside in the optional memory system 815 shown in FIG. 8 and/or in the control system 810. Accordingly, various innovative aspects of the subject matter described in this disclosure can be implemented in one or more non-transitory media having software stored thereon. The software may, for example, perform scene analysis, determine gain bounds for different clusters, determine gains for different frequency bands, apply gains to an audio signal to generate a modified or an enhanced audio signal, etc. The software may, for example, be executable by one or more components of a control system such as the control system 810 of FIG. 8.

In some examples, the apparatus 800 may include the optional microphone system 820 shown in FIG. 8. The optional microphone system 820 may include one or more microphones. In some implementations, one or more of the microphones may be part of, or associated with, another device, such as a speaker of the speaker system, a smart audio device, etc. In some examples, the apparatus 800 may not include a microphone system 820. However, in some such implementations the apparatus 800 may nonetheless be configured to receive microphone data for one or more microphones in an audio environment via the interface system 810. In some such implementations, a cloud-based implementation of the apparatus 800 may be configured to receive microphone data, or a noise metric corresponding at least in part to the microphone data, from one or more microphones in an audio environment via the interface system 810.

According to some implementations, the apparatus 800 may include the optional loudspeaker system 825 shown in FIG. 8. The optional loudspeaker system 825 may include one or more loudspeakers, which also may be referred to herein as “speakers” or, more generally, as “audio reproduction transducers.” In some examples (e.g., cloud-based implementations), the apparatus 800 may not include a loudspeaker system 825. In some implementations, the apparatus 800 may include headphones. Headphones may be connected or coupled to the apparatus 800 via a headphone jack or via a wireless connection (e.g., BLUETOOTH).

Some aspects of present disclosure include a system or device configured (e.g., programmed) to perform one or more examples of the disclosed methods, and a tangible computer readable medium (e.g., a disc) which stores code for implementing one or more examples of the disclosed methods or steps thereof. For example, some disclosed systems can be or include a programmable general purpose processor, digital signal processor, or microprocessor, programmed with software or firmware and/or otherwise configured to perform any of a variety of operations on data, including an embodiment of disclosed methods or steps thereof. Such a general purpose processor may be or include a computer system including an input device, a memory, and a processing subsystem that is programmed (and/or otherwise configured) to perform one or more examples of the disclosed methods (or steps thereof) in response to data asserted thereto.

Some embodiments may be implemented as a configurable (e.g., programmable) digital signal processor (DSP) that is configured (e.g., programmed and otherwise configured) to perform required processing on audio signal(s), including performance of one or more examples of the disclosed methods. Alternatively, embodiments of the disclosed systems (or elements thereof) may be implemented as a general purpose processor (e.g., a personal computer (PC) or other computer system or microprocessor, which may include an input device and a memory) which is programmed with software or firmware and/or otherwise configured to perform any of a variety of operations including one or more examples of the disclosed methods. Alternatively, elements of some embodiments of the inventive system are implemented as a general purpose processor or DSP configured (e.g., programmed) to perform one or more examples of the disclosed methods, and the system also includes other elements (e.g., one or more loudspeakers and/or one or more microphones). A general purpose processor configured to perform one or more examples of the disclosed methods may be coupled to an input device (e.g., a mouse and/or a keyboard), a memory, and a display device.

Another aspect of present disclosure is a computer readable medium (for example, a disc or other tangible storage medium) which stores code for performing (e.g., coder executable to perform) one or more examples of the disclosed methods or steps thereof.

While specific embodiments of the present disclosure and applications of the disclosure have been described herein, it will be apparent to those of ordinary skill in the art that many variations on the embodiments and applications described herein are possible without departing from the scope of the disclosure described and claimed herein. It should be understood that while certain forms of the disclosure have been shown and described, the disclosure is not to be limited to the specific embodiments described and shown or the specific methods described.

Various aspects of the present disclosure may be appreciated from the following Enumerated Example Embodiments (EEEs):

EEE1. A method of processing audio, comprising:
receiving, from one or sensors of at least two wearable audio playback devices, raw sensor data;
fusing raw sensor data to generate head movement data; predicting future head movement from the head movement data to generate orientation data;
recentering an audio scene using the syncrhonized orientation data or recentering status control data, the recentering including at least one of avoiding drifting from the audion scend or resetting head orientation; and
providing the orientation data or recentering status control data for synchronizing between a first device of the wearable audio playback devices to a second device of the wearable audio playback devices;

EEE2. The method of EEE1, wherein the wearable audio playback devices are wireless earbuds, the first device being a master earbud,, providing the orientation data or recentering status control data for synchronizing including predicting future head movement data or future orientation data for compensating transferring jittering, transferring delay and processing delay; the second device being a slave earbud; and
transferring the orientation data or recentering status data from the master earbud to the slave earbud;

EEE3. The method of EEE2, wherein predicting future head movement comprises at least one of predicting transfer latency, correcting jittering, or adjusting head movement based on known transferring status information.

EEE4. The method of EEE3, wherein the known transferring status information includes at least one of a transferring interval, a data drop rate, or a cache buffer length.

EEE5. The method of any of EEE1 to EEE4, wherein providing the orientation data comprises indexing the orientation data based on calculated data rate and data transfer latency.

EEE6. The method of EEE5, wherein indexing the orientation data or recentering status data based on calculated data rate and data transfer latency comprises:
determining that certain data was missed or delayed during transferring based on timestamps or data count; and
compensating for the missed data during indexing.

EEE7. The method of EEE6, wherein providing the recentering status data comprises the logic of determining the orientation of the virtual audio scene and the time of triggering the recentering.

EEE8. The method of any of EEE1 to EEE6, wherein the master and slave earbud can be exchanged for power consuming balance.

EEE9. A system comprising:
a processor; and a computer-readable medium storing instructions that, upon execution by the processor, causes the processor to perform operations of any one of EEE1 to EEE8.

EEE10. A computer-readable medium storing instructions that, upon execution by a processor, causes the processor to perform operations of any one of EEE1 to EEE8.

1. A method of utilizing head tracking data, the method comprising:
receiving, at each earbud of a pair of communicatively coupled earbuds, sensor data from a respective one or more sensors disposed in or on the earbud, and an audio stream from a user device;
determining, at each earbud of the pair of communicatively coupled earbuds, head orientation information based on the sensor data received by the earbud;
transmitting the determined head orientation information between the pair of communicatively coupled earbuds such that a leader earbud of the pair of communicatively coupled earbuds transmits head orientation information determined by the leader earbud to a follower earbud of the pair of communicatively coupled earbuds;
synchronizing, by at least the follower earbud of the pair of communicatively coupled earbuds, the head orientation information determined at the follower earbud with the head orientation information determined by the leader earbud, based at least in part on timing information associated with a timestamp at which the head orientation information was transmitted; and
rendering, by each earbud of the pair of communicatively coupled earbuds, the audio stream based on the synchronized head orientation data to present audio content by each earbud of the pair of communicatively coupled earbuds.

2. The method of claim 1, wherein determining the head orientation information at each earbud comprises fusing data from two or more sensors disposed in or on the earbud.

3. The method of claim 1, wherein determining the head orientation information comprises determining predicted head orientation data.

4. The method of claim 3, wherein the follower earbud is configured to utilize the predicted head orientation data to compensate for latency in receiving the head orientation information from the leader earbud.

5. The method of claim 1, further comprising smoothing the synchronized head orientation data, wherein the synchronized head orientation data utilized to present audio content comprises the smoothed synchronized head orientation data.

6. The method of claim 1, wherein transmitting the determined head orientation information between the pair of communicatively coupled earbuds comprises including the timing information in a data stream transmitted from the leader earbud to the follower earbud.

7. The method of claim 6, further comprising determining, at the follower earbud, whether data is missing in the head orientation information received from the leader earbud based at least in part on the timing information received from the leader earbud.

8. The method of claim 6, wherein synchronizing the determined head orientation data at the follower earbud comprises synchronizing the determined head orientation data determined at the follower earbud based on the one or more sensors of the follower earbud with the head orientation data received from the leader earbud using the timing information.

9. The method of claim 1, wherein determining, at each earbud, the head orientation information comprises recentering head orientation data generated based on the sensor data to compensate for drift in the sensor data.

10. The method of claim 1, wherein each earbud comprises a cache buffer to store at least the head orientation data.

11. The method of claim 10, wherein head orientation data is transmitted from a cache buffer of the leader earbud to the follower earbud at a timing interval dependent on at least a data transmission rate and a latency associated with transmitting the determined head orientation information between the pair of communicatively coupled earbuds.

12. The method of claim 1, further comprising resampling the sensor data prior to determining the head orientation information to compensate for a difference between a sampling rate used to acquire the sensor data and a sampling rate used to determine the head orientation information.

13. The method of claim 1, further comprising resampling the determined head orientation information prior to transmitting the determined head orientation information to compensate for a difference between a sampling rate used to determine the head orientation information and a sampling rate used to transmit the determined head orientation information.

14. The method of claim 1, further comprising resampling the synchronized head orientation data prior to utilizing the synchronized head orientation data to present the audio content to compensate for a difference between a sampling rate used to synchronize the determined head orientation data and a sampling rate used to process the audio content.

15. The method of claim 1, wherein transmitting the determined head orientation information comprises utilizing a BLUETOOTH communication protocol.

16. A system comprising:
a pair of communicatively coupled earbuds, each earbud comprising a processor and one or more sensors; and
a computer-readable medium storing instructions that, upon execution by the processors of the communicatively coupled earbuds, causes the processors to perform operations of claim 1.

17. A computer-readable medium storing instructions that, upon execution by processors of a pair of communicatively coupled earbuds, causes the processors to perform operations of claim 1.
